(19) United States
(12) Patent Application Publication
(10) Pub. No.: US 2014/0002330 A1
(43) Pub. Date: Jan. 2, 2014

(54) MULTI-DISPLAY SYSTEM

(71) Applicant: MITSUBISHI ELECTRIC CORPORATION, Tokyo (JP)

(72) Inventors: Sanae TERAMAE, Tokyo (JP); Yoshinori ASAMURA, Tokyo (JP)

(73) Assignee: MITSUBISHI ELECTRIC CORPORATION, Tokyo (JP)

(21) Appl. No.: 13/874,140

(22) Filed: Apr. 30, 2013

(30) Foreign Application Priority Data
Jun. 29, 2012 (JP) 2012-146394

(51) Int. Cl. G09G 3/00

(52) U.S. Cl. CPC G09G 3/00
USPC 345/30

(57) ABSTRACT

A multi-display system includes: a video window arrangement and display unit that arranges and displays all the video windows, which should be displayed, only on some displays in a multi-display constructed by arraying a plurality of displays; and a power supply controller that controls power of the display in which the video window is not displayed.

### BACKGROUND OF THE INVENTION

1. Field of the Invention

The present invention relates to a multi-display system that is constructed by a combination of a plurality of displays.

2. Description of the Background Art

A multi-display system in which a plurality of displays are arranged into, for example, a lattice shape to construct one display screen (display) is widely used as a video image display device that is used to monitor an infrastructure field such as electric power, traffic, and plant.

In general, in the multi-display system, in order to simultaneously display a plurality of video images on the display screen (display), a video signal processor is used to display the plurality of video images with arbitrary size, position, and priority, and one or a plurality of video images are selected from an input video signal and output to the video image display device.

Nowadays, power consumption of the individual display increases with the advance of enlargement and high-brightness of the display. Therefore, power saving of the multi-display system constructed by the plurality of displays becomes a problem.

Conventionally, there is a technology of individually managing power of the display according to usage of each display in order to reduce the power consumption of the display. For example, there is a technology of causing the display, in which a state in which a mouse pointer or a video window in an active state is not displayed is continued for a given time, to transition to a low-power-consumption mode in the plurality of displays (see Japanese Patent No. 3831538).

In the multi-display system used in the monitoring or the like, the video image is not displayed in a single video window, but frequently the video image is displayed in a plurality of video windows and used on a multi-display. In a case where the technology disclosed in Japanese Patent No. 3831538 is used in such a running mode, the display in which the video window in an active state is not displayed is caused to transition to the low-power-consumption mode, and the video image is not displayed. Therefore, unfortunately it is necessary to periodically put all the video windows (display target video windows) necessary for a user into the active state in order to always maintain all the video windows in a display state.

In a usage mode of the multi-display system, usually the video images are displayed on all the displays as many as possible. In the low-power-consumption mode, sometimes the power consumption is reduced by decreasing the number of video windows used to display the video images or the number of displays used to display the video images. In this case, a running state in the above low-power-consumption mode can be implemented by manually setting a power state of the individual display. However, it is necessary to perform the power setting of the display every time the running state during the normal mode and the running state during the low-power-consumption mode are switched, and unfortunately it takes trouble and time.

### SUMMARY OF THE INVENTION

It is an object of the present invention to provide a multi-display system in which a video window necessary to display a video image can easily be displayed while the power consumption is suppressed.

In accordance with an aspect of the present invention, a multi-display system includes: a video window arrangement and display unit that arranges and displays all video windows, which should be displayed, only on some displays in a multi-display constructed by arraying a plurality of displays; and a power supply controller that controls power of the display in which the video window is not displayed.

According to the aspect of the present invention, all the video windows, which should be displayed, are arranged and displayed on some displays to perform the power control of the display in which the video window is not displayed, so that the video window necessary to display the video image can properly be arranged while the power consumption is suppressed.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram illustrating a configuration of a multi-display system according to a preferred embodiment of the present invention;

FIG. 2 is a view illustrating display information managed by display information management means according to a preferred embodiment of the present invention;

FIG. 3 is a view illustrating video window layout information managed by layout information management means according to a preferred embodiment of the present invention;

FIG. 4 is a view illustrating a display power setting list managed by the layout information management means according to a preferred embodiment of the present invention;

FIG. 5 is a flowchart illustrating an operation of video window layout producing means according to a preferred embodiment of the present invention;

FIG. 6 is a flowchart illustrating an operation of display power setting list producing means according to a preferred embodiment of the present invention;

FIG. 7 is a flowchart illustrating an operation of an overlapping determination of a video window drawing region and a display region of a display according to a preferred embodiment of the present invention;

FIG. 8 is a flowchart illustrating an operation in producing a video window layout according to a preferred embodiment of the present invention;

FIG. 9 is a view illustrating an example of the video window layout according to a preferred embodiment of the present invention;

FIG. 10 is a view illustrating an example of video window layout information according to a preferred embodiment of the present invention;

FIG. 11 is a view illustrating an example of a display power setting list according to a preferred embodiment of the present invention;

FIG. 12 is a flowchart illustrating an operation in producing the video window layout according to a preferred embodiment of the present invention;

FIG. 13 is a view illustrating a display target video window selection screen in producing the video window layout according to a preferred embodiment of the present invention;

FIGS. 14A and 14B are views illustrating an example of the video window layout according to a preferred embodiment of the present invention;

FIG. 15 is a view illustrating an example of the video window layout information according to a preferred embodiment of the present invention;

FIG. 16 is a view illustrating an example of the display power setting list according to a preferred embodiment of the present invention; and

FIG. 17 is a flowchart illustrating an operation in switching a layout according to a preferred embodiment of the present invention.

### DESCRIPTION OF THE PREFERRED EMBODIMENTS

Hereinafter, preferred embodiments of the present invention will be described with reference to the accompanying drawings.

### First Preferred Embodiment

(Configuration)

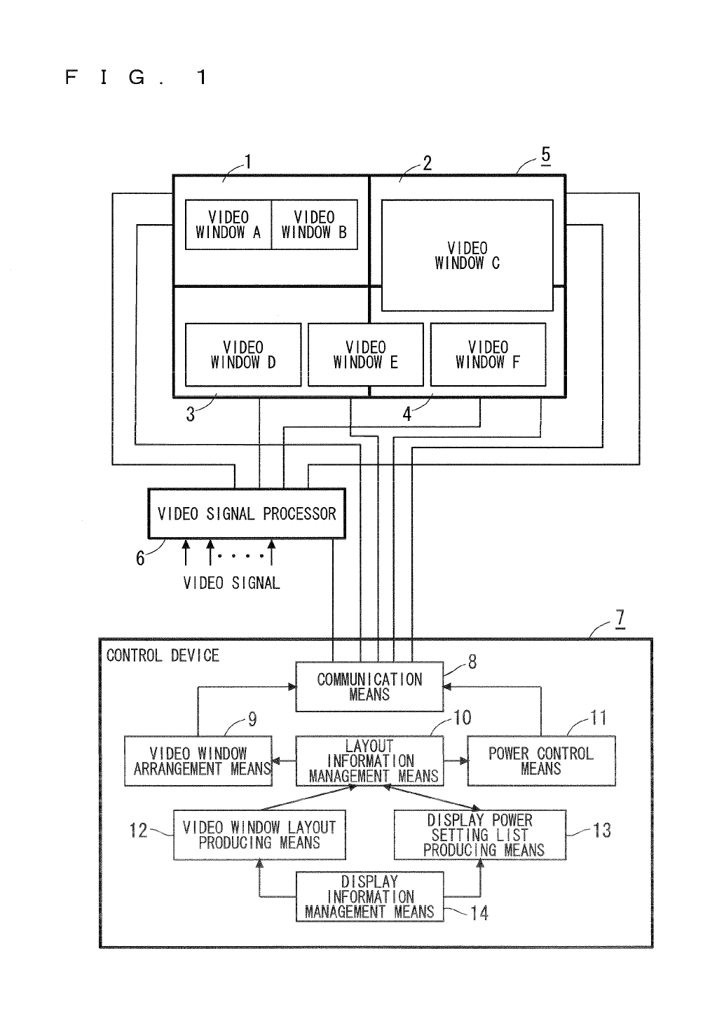

FIG. 1 is a block diagram illustrating a configuration of a multi-display system according to a first preferred embodiment. As illustrated in FIG. 1, the multi-display system includes a multi-display 5, a video signal processor 6, and a control device 7.

For example, the multi-display 5 is a display group in which a plurality of displays 1 to 4 are arrayed into a lattice shape, and the multi-display 5 receives a video image, which is produced by the video signal processor 6 based on a video signal, through a DVI cable or the like, and displays the video image.

The displays 1 to 4 are DLP (Digital Light Processing) (registered trademark) projector type or liquid crystal type display devices in each of which a lamp or an LED (Light Emitting Diode) is used as a light source. For example, each of the displays 1 to 4 has a resolution of 1920 pixels in horizontal direction and 1200 pixels in vertical direction. The multi-display 5 has a 3840-by-2400-pixel screen size as a whole.

For example, the video signals associated with the video images of a plurality of monitoring cameras and video image output from a PC or the like are input to the video signal processor 6, and the video signal processor 6 scales the video signals to the video image having any size, and displays the video signals in any position on the 3840-by-2400-pixel multi-display 5 as video windows. In the example in FIG. 1, video windows A to F are arranged while some video windows straddle the video windows. However, actually the video signal processor 6 outputs the 1920-by-1200-pixel video image corresponding to each of the displays 1 to 4.

As illustrated in FIG. 1, the control device 7 includes communication means 8, video window arrangement means 9, layout information management means 10, power control means 11, video window layout producing means 12, display power setting list producing means 13, and display information management means 14. The control device 7 can be constructed by a PC, on which a Windows (registered trademark of Microsoft) operating system or a Linux (registered trademark) operating system operates and which includes a general-purpose communication interface such as RS-232C and Ethernet (registered trademark).

The communication means 8 conducts communication with the multi-display 5 and the video signal processor 6 to perform state monitoring and various kinds of control to the displays 1 to 4 and the video signal processor 6. For example, the multi-display 5, the video signal processor 6, and the control device 7 are connected to an Ethernet (registered trademark) cable, thereby conducting communication with one another.

The video window arrangement means 9 arranges and displays the video windows on the multi-display 5 based on video window layout information. The video window layout information is information, which is managed by the layout information management means 10 and indicates a layout of the video windows.

The layout information management means 10 retains and manages the video window layout information produced by the video window layout producing means 12 and a display power setting list, which is produced by the display power setting list producing means 13 and indicates a power setting of each display.

The power control means 11 performs power control of the displays 1 to 4 through the communication means 8 based on information on the display power setting list.

The video window layout producing means 12 fixes a video window arrangement for the multi-display 5, and retains the content as video window layout information in the layout information management means 10.

According to the video window layout information managed by the layout information management means 10, the display power setting list producing means 13 produces the display power setting list indicating a power setting of each display, and retains the display power setting list in the layout information management means 10.

The display information management means 14 retains and manages a position and size information (display information) of each of the displays 1 to 4 constituting the multi-display 5. The display information management means 14 can also retain and manage a display target video window list indicating the video window of a display target and video window layout producing mode information which is the information on a layout mode of the video window.

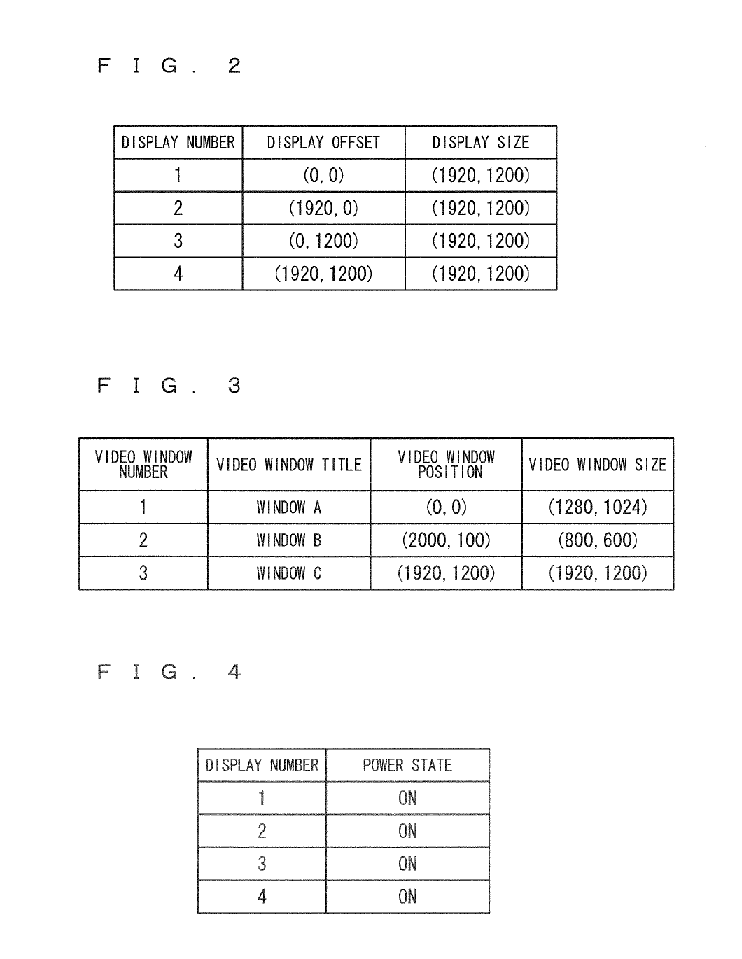

FIG. 2 is a view illustrating an example of the display information managed by the display information management means 14. The display information includes a display number, a display offset, and a display size. For example, the display offset is a coordinate at an upper left end of each display when a coordinate at an upper left end of the whole multi-display 5 is set to (0,0). The display offset has a unit of pixel.

FIG. 3 is a view illustrating an example of the video window layout information managed by the layout information management means 10. The video window layout information includes a video window number, a video window title, a video window position, and a video window size. The video window number identifies the video window, and the video window position is the coordinate at the upper left end of the video window with respect to a display region of the whole multi-display. The video window position and the video window size have a unit of pixel.

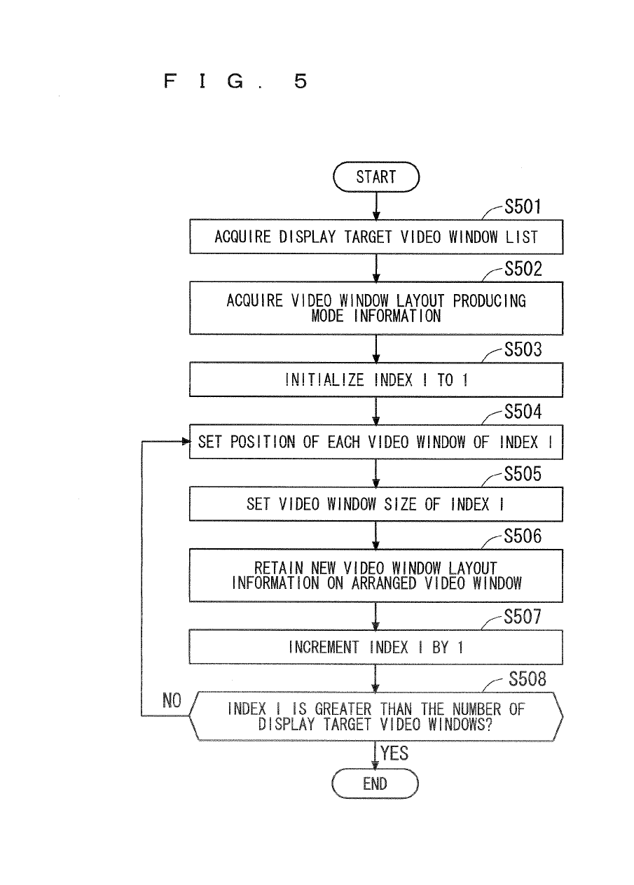

FIG. 4 is a view illustrating an example of the display power setting list managed by the layout information management means 10. The display power setting list includes a display number and power-state information. The display number included in the display power setting list corresponds to the display number included in the display information.

(Operation of Video Window Layout Producing Means)

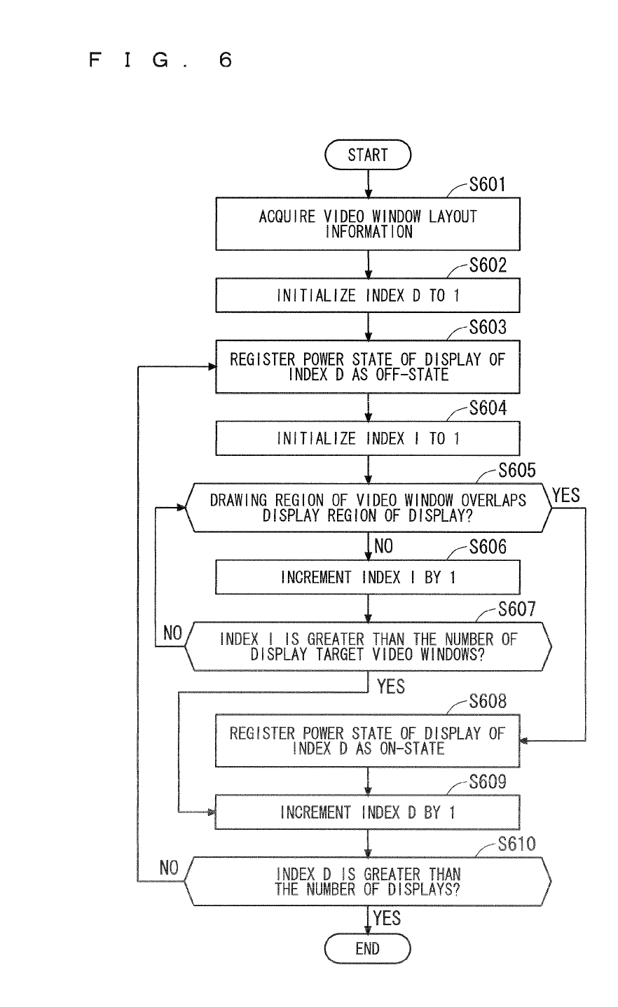

FIG. 5 is a flowchart illustrating an operation of the video window layout producing means 12.

Firstly, the video window layout producing means 12 acquires the display target video window list indicating the video window which is the display target from the display information management means 14 (Step S501). The video windows, which are necessary to display all the video images necessary for a user, are listed in the display target video window list. The video window which is the display target may arbitrarily be set, and the necessary video image may be displayed in the selected video window. The case that all the video windows are listed as the display target video window is described in the first preferred embodiment.

The video window layout producing means 12 acquires the video window layout producing mode information from the display information management means 14 (Step S502). For example, the video window layout producing mode information includes a setting item associated with the production of the video window layout, in which the video windows are arranged while one display size is resized into the display sizes of one-fourth, one-ninth, or one-sixteenth (an automatic arrangement mode). At this point, in a new video window layout, the video window is not arranged in at least one display.

The video window list and the video window layout producing mode information are set by the user before the operation is performed by the video window layout producing means 12, and the video window list and the video window layout producing mode information can be retained in the display information management means 14.

Then the video window layout producing means 12 initializes an index I to 1. The index I indicates the currently-processed video window number (Step S503). The video window layout producing means 12 repeatedly performs Steps S504 to S508 described below as many times as the number of video windows which are the display target.

In Step S504, the position of the video window having the index I is set in the produced video window layout. In Step S504, the position of the video window is set using a value, in which a display region is divided according to the currently-set video window layout producing mode. For example, the displays in which the video windows are arranged can be selected in the ascending order of the display number. For example, a coordinate value is set in the display such that the video windows are arranged while the positions of the video windows are shifted from the upper left to the lower right in favor of the right direction.

In Step S505, the size of the video window is set in the index I. In Step S505, the display region is divided into the regions of one-fourth, one-ninth, or the like according to the currently-set video window layout producing mode, and the video window size is set to the divided display region.

In Step S506, the new video window layout information on the arranged video window having the index I is retained in the layout information management means 10.

In Step S507, the index I indicating the currently-processed video window number is incremented by 1.

Whether the index I is greater than the number of display target video windows is determined in Step S508. When the index I is greater than the number of display target video windows (YES in Step S508), namely, when all the video windows which are the display target are registered in the video window layout, the operation is ended. On the other hand, when the index I is less than or equal to the number of display target video window (NO in Step S508), the flow returns to Step S504.

(Operation of Display Power Setting List Producing Means)

FIG. 6 is a flowchart illustrating an operation of the display power setting list producing means 13.

The display power setting list producing means 13 acquires the video window layout information from the layout information management means 10 (Step S601). The video window layout information can arbitrarily be selected from not only the video window layout information that is displayed on the multi-display 5 at a time point when the display power setting list producing means 13 is called but also all the pieces of video window layout information managed by the layout information management means 10.

Then the display power setting list producing means 13 initializes an index D to 1. The index D indicates the currently-processed display number (Step S602). The display power setting list producing means 13 repeatedly performs Steps S603 to S610 described below to all the displays 1 to 4 constituting the multi-display 5.

In Step S603, the power state of the display having the index D, which is the power setting target, is put into an off-state (non-use), and the power state is registered in the display power setting list.

Next, in Step S604, the index I is initialized to 1. The index I indicates the video window number that becomes a criterion in Step S605 described next.

Whether a drawing region of the video window having the index I overlaps the display region of the display having the index D is determined in Step S605. When the drawing region of the video window having the index I overlaps the display region of the display having the index D (YES in Step S605), the flow goes to Step S608. When the drawing region of the video window having the index I does not overlap the display region of the display having the index D (NO in Step S605), the flow goes to Step S606. A method for determining the overlap of the video window having the index I and the display having the index D is described later.

In Step S608, the power state of the display having the index D is put into an on-state (use), and the power state is registered in the display power setting list. Then the flow goes to Step S609.

In Step S606, the index I is incremented by 1, and the video window which is the processing target is changed to the next video window. Then the flow goes to Step S607.

Whether the index I is greater than the number of display target video windows is determined in Step S607. When the index I is greater than the number of display target video windows (YES in Step S607), the flow goes to Step S609. When the index I is less than or equal to the number of display target video windows (NO in Step S607), the flow returns to Step S605.

In Step S609, the index D is incremented by 1. Then the flow goes to Step S610.

Whether the index D is greater than the number of displays constituting the multi-display system is determined in Step S610. When the index D is greater than the number of displays (YES in Step S610), the operation is ended. When the index D is less than or equal to the number of displays (NO in Step S610), the flow returns to Step S603.

When the negative determination is made in Step S605, the processing transitions to the next display while the registration content of the display power setting list is maintained in the off-state (non-use), and the processing is sequentially performed to all the video windows included in the video window layout.

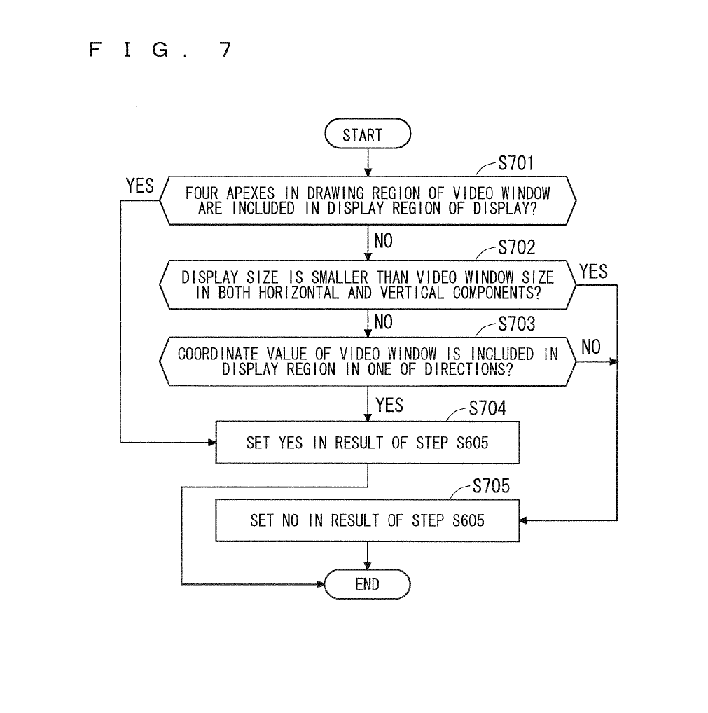

FIG. 7 is a flowchart illustrating a procedure for determining a region overlap of the video window having the index I and the display having the index D in Step S605.

Whether coordinates of four apexes in the drawing region of the video window, which is obtained from the position information and size information on the video window having the index I, are included in the display region of the display having the index D is firstly checked in Step S701. When the coordinates of four apexes are included in the display region of the display having the index D (YES in S701), the flow goes to Step S704. When the coordinates of four apexes are not included in the display region of the display having the index D (NO in S701), the flow goes to Step S702.

In Step S702, a horizontal and vertical components of the size of the video window having the index I are compared to those of the size of the display having the index D. When the size of the video window is smaller than the size of the display in both the horizontal and vertical components, the flow goes to Step S705. When the size of the video window is larger than the size of the display in one of the horizontal and vertical components, the flow goes to Step S703.

In a component direction (at least one of the horizontal direction and the vertical direction) in which the size of the video window having the index I is larger than the size of the display having the index D, a value in which a value of the display offset is added to the coordinate value of the video window position is set to a new coordinate value, and whether the point indicated by the new coordinate value is included in the display region is checked in Step S703. When the point is included in the display region in one of the directions, the flow goes to Step S704. When the point is not included in the display region in both the directions, the flow goes to Step S705.

In Step S704, “YES” is set in the result of Step S605, namely, a determination that the video window having the index I is included in the region of the display having the index D is made. Then the operation is ended.

In Step S705, “NO” is set in the result of Step S605, namely, a determination that the video window having the index I is not included in the region of the display having the index D is made. Then the operation is ended.

(Layout Producing Operation)

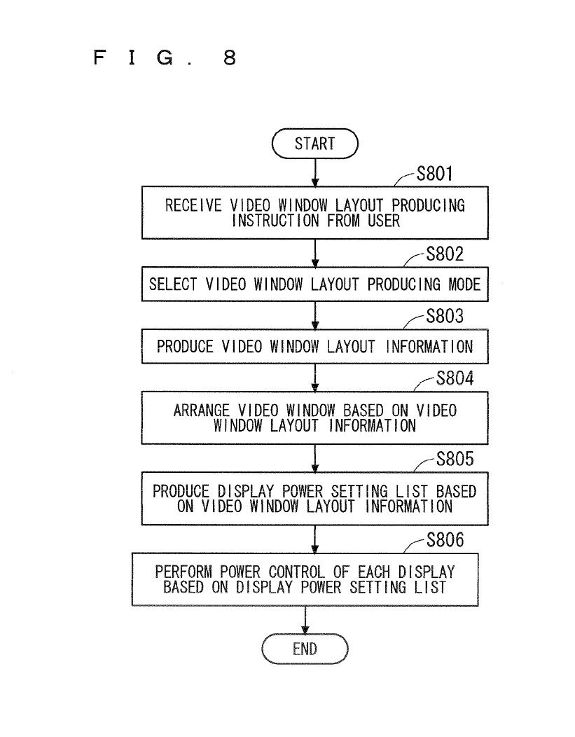

FIG. 8 is a flowchart illustrating an operation of the control device 7 when the user issues an instruction to produce the video window layout.

Firstly in Step S801, the control device 7 receives a video window layout producing instruction from the user. There is no particular limitation. However, for example, the video window layout producing instruction may be executed in a case where the multi-display system is set to a low-power-consumption mode.

Next in Step S802, the control device 7 presents the video window layout producing mode to the user, and causes the user to select one of the modes. The video window layout producing mode is not limited to the case that the video window layout producing mode is selected from previously-set contents, but the video window layout producing mode may be the case that the user sets the individual content.

In Step S803, in order to display the video image based on all the video signals input to the video signal processor 6, the control device 7 causes the video window layout producing means 12 to produce the video window layout information indicating the layout of the video windows. The video window layout information is produced based on the video window layout producing mode selected or set in Step 802. At this point, in the new video window layout, the video window is not arranged in at least one display. The video window layout is produced using the display target video window.

Next in Step S804, the control device 7 causes the video window arrangement means 9 to arrange the video window based on the video window layout information.

Next in Step S805, the control device 7 causes the display power setting list producing means 13 to produce the display power setting list based on the video window layout information. In the display power setting list, the display in which the video window is not arranged is referred to from the video window layout information to issue an instruction to control the power of the display (for example, to power off the display).

In Step 806, the control device 7 causes the communication means 8 to conduct communication with the displays 1 to 4, and causes the power control means 11 to perform power control (for example, the power is turned off) of each of the displays 1 to 4 based on the produced display power setting list.

FIG. 9 is a view illustrating an example of the video window layout for the purpose of power saving. In the example in FIG. 9, eight video signals are input to the video signal processor 6, and in a case where the video images named the video windows A to H can be displayed on the multi-display 5 based on the video signals respectively, the video window layout producing mode is set to the automatic arrangement mode, in which the video windows are arranged while resized into the display sizes of one-fourth, and the video windows are laid out.

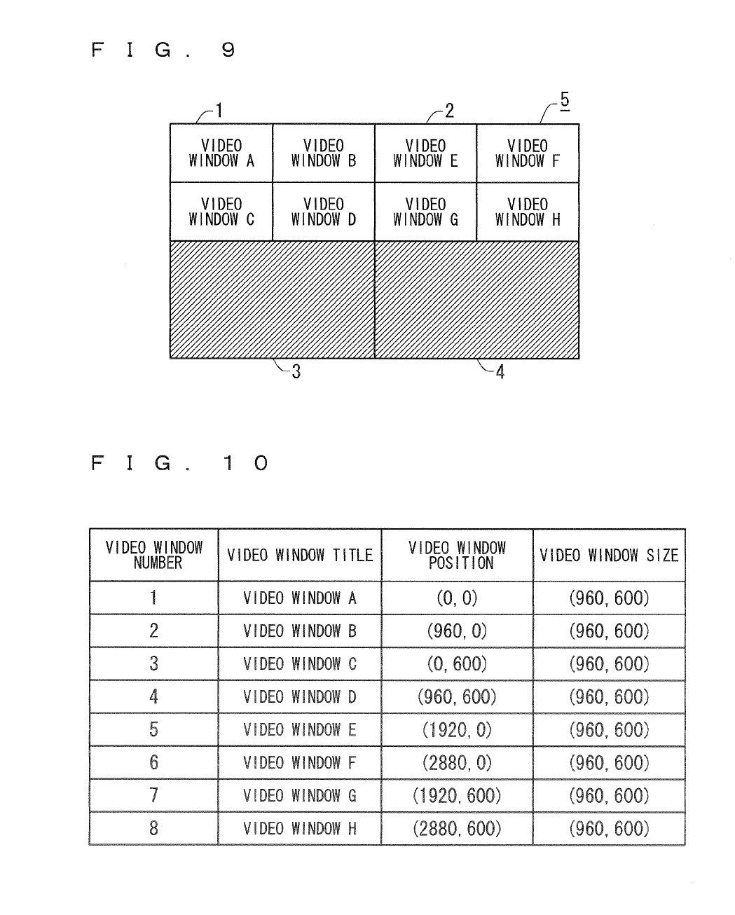

When the user issues the video window layout producing instruction, the video window layout producing means 12 fixes the positions and sizes of the eight video windows to values (illustrated in FIG. 10), which are indicated by the video window layout information produced by the video window layout producing means 12, and the video windows are displayed on the multi-display 5 with the video window arrangement as shown in FIG. 9. In FIG. 9, the video windows A to D are arranged in the display 1, the video windows E to H are arranged in the display 2, but the video window is not arranged in the displays 3 and 4.

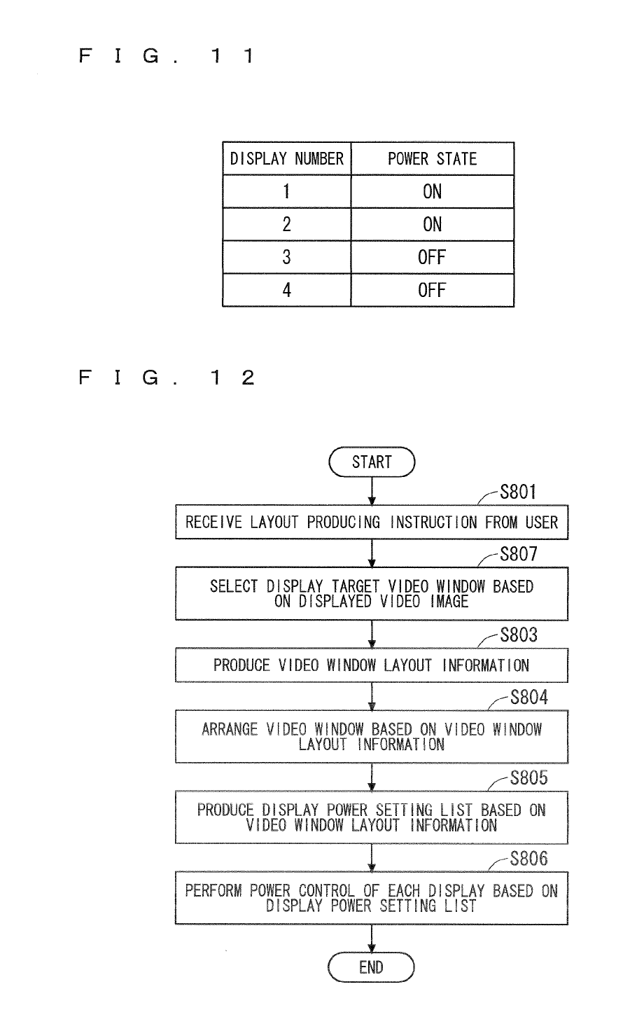

The display power setting list producing means 13 determines that the displays 3 and 4 in which the video window is not arranged are non-use regions, and display power setting list information as shown in FIG. 11 is produced. Then, in Step 806, the power of the displays 3 and 4 in which the video images are not displayed is controlled (the power is set to the off-state).

Thus, the display in which the video image is not displayed is made by the arrangement of the video windows, and the power of the display is controlled, which allows the reduction of the power consumption of the display device. Further, because a load on a power supply circuit of the display device is also decreased, durability of the whole display device is improved in long-term use.

(Modification)

In a case where the displays 1 to 4 have at least one operating state, such as a standby state and a display circuit off-state, in which the power saving state can be maintained instead of the main power on and off states, the multi-display system can deal with various running modes such that the standby state and the display circuit off-state can be selected in an execution content of the power control of the display in which the power state is set to the off-state in the display power setting list.

For example, the power consumption can largely be reduced when the display in which the power state of the display power setting list is set to the off-state is set to the main power off-state, and the multi-display system in which a return time is shortened in switching the running mode can be realized when the display is set to the power saving state (such as the standby state and the display circuit off-state).

In the first preferred embodiment, the display on which the video window is displayed is fixed. However, the video window is not necessarily displayed on the fixed display. For example, the control may be performed such that displays are circulated every time the video window layout is produced. In this case, because current-carrying times of the displays constituting the multi-display can substantially be equalized, a lifetime of each display can be kept constant.

Further, in the example in FIG. 9, the displayed video images are tiled on two displays. Alternatively, the video images may be displayed on one display while overlapping each other.

Furthermore, in the first preferred embodiment, the video windows are displayed on some displays of the multi-display 5 such that the video windows are moved to adopt the new video window layout. Alternatively, in a case where the video windows are displayed on some displays of the multi-display 5 before the new video window layout is adopted, the video window layout may be produced without moving the video windows.

(Effect)

According to the first preferred embodiment of the present invention, the multi-display system includes the video window arrangement means 9 serving as the video window arrangement and display unit and the power control means 11 serving as the power supply controller. The video window arrangement means 9 arranges and displays all the video windows, which should be displayed, only on some displays of the multi-display 5 in which the plurality of displays are arrayed. The power control means 11 controls the power of the display on which the video window is not displayed.

According to this configuration, all the video windows that should be displayed are arranged in and displayed on some displays, and the power control means 11 performs the power control to the display on which the video window is not displayed, which allows the video windows necessary to display the video image to be properly arranged while the power consumption is suppressed.

The video window arrangement means 9 and the power control means 11 automatically and collectively arrange the video windows to perform the power control, so that the power saving of the multi-display system can be realized while the user does not manually perform the video window arrangement and the individual power setting of display in consideration of the power saving.

According to the first preferred embodiment of the invention, the video window arrangement means 9 scales the video window to enable all the video windows that should be displayed to be arranged only on some displays.

According to this configuration, the video windows arranged on the multi-display 5 can properly and collectively be arranged on some displays of the multi-display 5.

### Second Preferred Embodiment

A multi-display system according to a second preferred embodiment will be described below. In the first preferred embodiment, the control is performed in producing the video window layout such that the video images based on all the video signals input to the video signal processor 6 are arranged on some displays. On the other hand, in the second preferred embodiment, some video windows (not every but only some video windows) which are the display target are selected in producing the video window layout. In other words, some of the video signals input to the video signal processor 6 correspond to all the video images that should be displayed, and the video windows corresponding to these video images are arranged on some displays. However, the selected video window is one in which the video image is displayed based on the video signal, which is previously selected in order to display in, for example, the low-power-consumption mode. In the second preferred embodiment, the same constituent as the first preferred embodiment is designated by the same numeral and the description is not given.

In the second preferred embodiment, the display target video window is selected while corresponding to the video image displayed in the low-power-consumption mode in the layout producing procedure in FIG. 8, which is described in the first preferred embodiment.

FIG. 12 is a flowchart illustrating the operation of the control device 7 when the user issues the instruction to produce the video window layout.

Because Step S801 and Steps S803 to S806 are identical to those in FIG. 8, the description is not given.

In Step S807, the control device 7 presents the video window layout producing mode to the user, and causes the user to select one of the modes. At this point, the display target video window, which is used to produce the video window layout information in Step S803, is selected based on the video image displayed in the low-power-consumption mode.

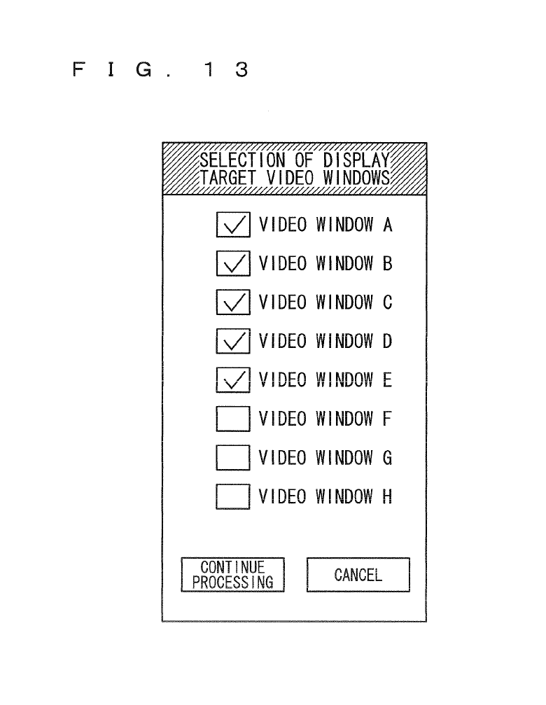

For example, the display target video window can be selected using a selection screen in which a check box is used as illustrated in FIG. 13. In the example in FIG. 13, eight video signals are input to the video signal processor 6 and in a case where the video images named the video windows A to H can be displayed on the multi-display 5 based on the video signals respectively, the user selects the video windows A to E as the display target. That is, in the selection during the low-power-consumption mode, the video images corresponding to the video windows A to E are displayed while the video images corresponding to the video windows F to H are not displayed.

The user arbitrarily selects the video window that the user would like to display in the low-power-consumption mode, so that the video images suitable for a utility form can be displayed.

(Effect)

According to the second preferred embodiment of the present invention, the video window arrangement means 9 displays only the video windows corresponding to the previously-selected display target video image only on some displays.

According to this configuration, in the video images based on the video signals input to the video signal processor 6, all the video images necessary to display for the user can collectively be displayed on some displays as the display target.

### Third Preferred Embodiment

A multi-display system according to a third preferred embodiment will be described below. In the first preferred embodiment, the control is performed in producing the video window layout such that the video images are arranged on some displays based on all the video signals input to the video signal processor 6. On the other hand, in the third preferred embodiment, the control is performed such that the video windows, which are displayed on the multi-display immediately before the production of the video window layout, for example, immediately before the switching to the low-power-consumption mode, are arranged on some displays. That is, the video windows that are displayed on the multi-display immediately before the production of the video window layout correspond to all the video images that should be displayed, and the video windows in which the video images are displayed are arranged on some displays. In the third preferred embodiment, the same constituent as the first preferred embodiment is designated by the same numeral and the description is not given.

In the third preferred embodiment, the video windows displayed on the multi-display 5 immediately before the production of the video window layout are used as the display target video window in the layout producing procedure in FIG. 8 described in the first preferred embodiment. A layout retaining mode in which the currently-displayed video window arrangement is directly retained as the new video window layout can be set as a type of the layout producing mode set in Step S802 of FIG. 8.

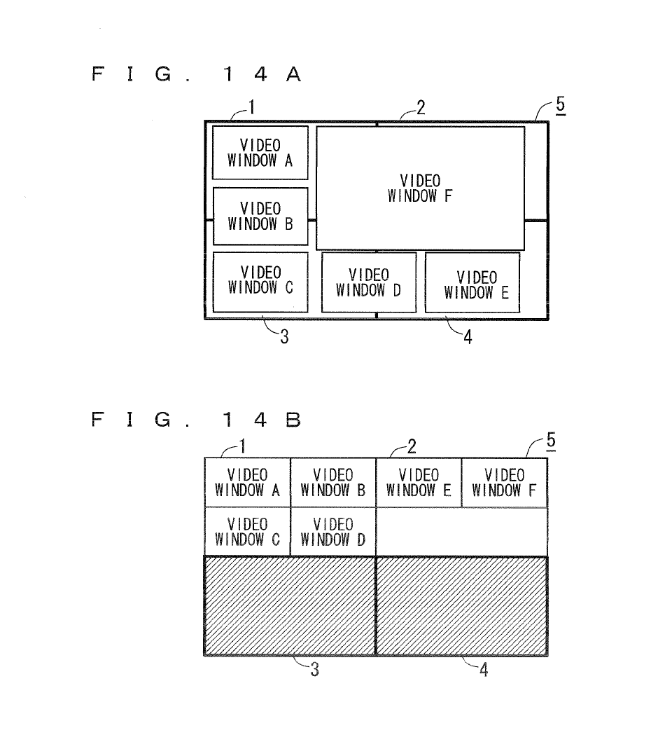

FIGS. 14A and 14B are views illustrating an example of the video window layout when the video window layout is produced in the third preferred embodiment. FIG. 14A illustrates a video window arrangement state before the video window layout is produced, and FIG. 14B illustrates a video window arrangement state after the video window layout is produced.

In FIGS. 14A and 14B, eight video signals are input to the video signal processor 6, and in a case where the video images named the video windows A to H can be displayed on the multi-display 5, the layout is produced while the video window layout producing mode is set to the automatic arrangement mode in which the size of the video window is resized into display sizes of one-fourth and arranged.

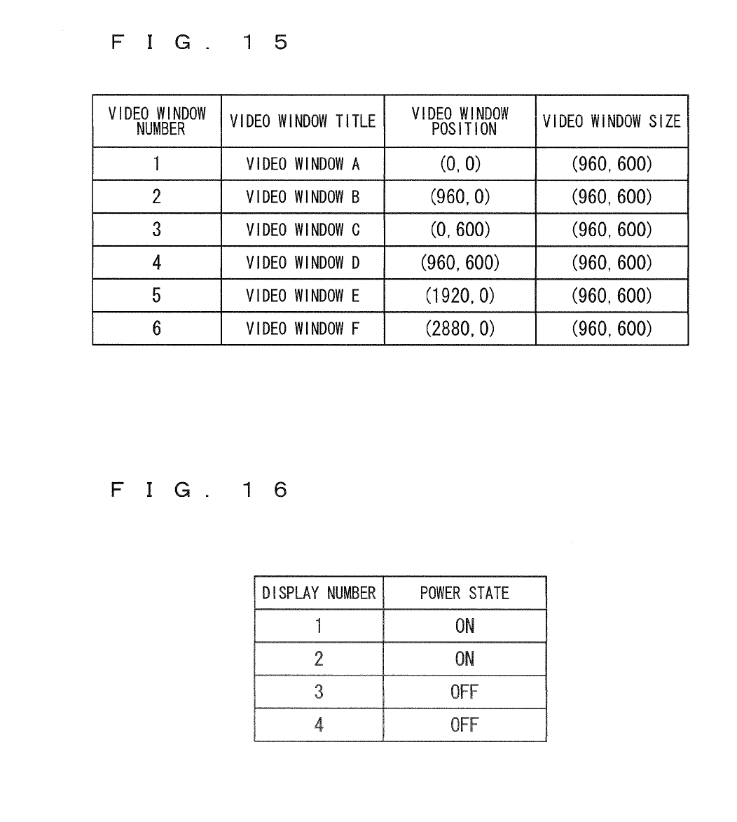

In the eight video windows A to H, the video windows A to F are arranged in the video window layout in FIG. 14A. At this point, when the layout producing instruction is issued, the video window layout producing means 12 changes the positions and sizes of the video windows to the values indicated by the video window layout information in FIG. 15, and displays the video windows on the multi-display 5 in the arrangement in FIG. 14B.

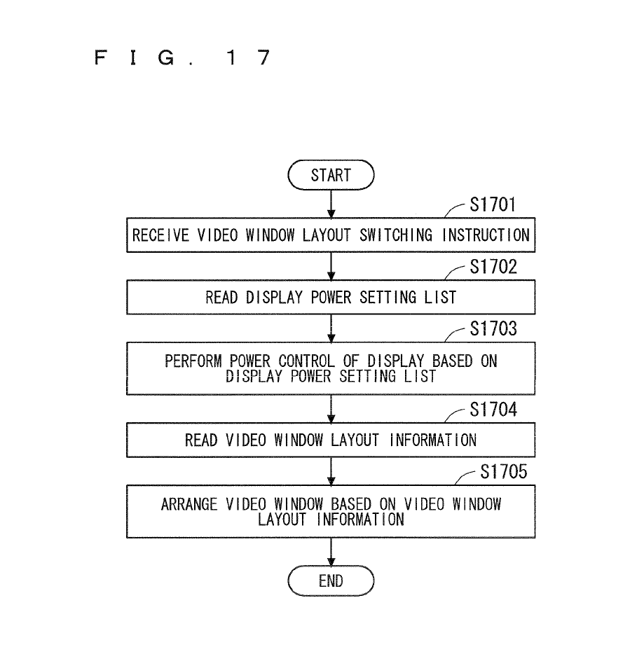

The display power setting list producing means 13 determines that the displays 3 and 4 are the non-use regions, and produces the display power setting list information in FIG. 16. Then the displays 3 and 4 in which the video images are not displayed are powered off

In the third preferred embodiment, because the video window displayed immediately before the production of the video window layout can directly be used as the display target video window during the low-power-consumption mode, the procedure to select the video window can be eliminated in a case where the already-displayed video windows are collectively displayed.

Because the power control of the display can be performed in any video window layout by the combination with the video window layout retaining mode, the power saving can be implemented in the video window layout desired by the user.

(Effect)

According to the third preferred embodiment of the present invention, the video window arrangement means 9 displays the video windows, which are displayed on the multi-display 5 immediately before the low-power-consumption mode, on some displays in response to the low-power-consumption mode.

According to this configuration, the procedure to select the video window can be eliminated in a case where the already-displayed video windows are collectively displayed.

### Fourth Preferred Embodiment

A multi-display system according to a fourth preferred embodiment will be described below. In the fourth preferred embodiment, the same constituent as the first preferred embodiment is designated by the same numeral, and the description is not given.

In the fourth preferred embodiment, for example, the video window arranged on the display in the low-power-consumption mode and the video window layout are previously registered in the layout information management means 10, and the video window arrangement and the power control of the display are performed based on the registered information in the low-power-consumption mode. The fourth preferred embodiment can also be applied to the case that only the video window layout is previously registered.

FIG. 17 is a flowchart illustrating the operation of the control device 7 in receiving the instruction to switch the video window layout to the registered video window layout from the user.

Firstly, in Step S1701, the control device 7 receives a video window layout switching instruction from the user.

Next in Step S1702, the control device 7 reads the display power setting list from the layout information management means 10.

Then in Step S1703, the control device 7 causes the communication means 8 to perform the power control of the displays 1 to 4 based on the display power setting list.

Next in Step S1704, the control device 7 reads the video window layout information from the layout information management means 10.

Finally, in Step S1705, the control device 7 causes the video window arrangement means 9 to arrange the video windows based on the video window layout information.

In the fourth preferred embodiment, the type and display pattern of the video window to be displayed and the information on the power setting of each display are read from the layout information management means 10. Therefore, the video window arrangement and the power control of the display can be performed, and the running mode can easily be changed. In the above operation, the video window layout information may be read to arrange the video window before the display power setting list is read to perform the power control of the display.

(Effect)

According to the fourth preferred embodiment of the present invention, the video window arrangement means 9 displays all the video windows, which should be displayed, only on some displays based on the previously-set video window layout.

According to this configuration, the use of the layout information in which the video window layout and the power setting information on the display are paired can easily switch the running mode of the multi-display system (for example, the normal mode and the low-power-consumption mode).

A free combination of the preferred embodiments, a modification of any constituent of each preferred embodiment, and elimination of any constituent of each preferred embodiment can be performed without departing from the scope of the present invention.

While the invention has been shown and described in detail, the foregoing description is in all aspects illustrative and not restrictive. It is therefore understood that numerous modifications and variations can be devised without departing from the scope of the invention.

What is claimed is:

1. A multi-display system comprising:
a video window arrangement and display unit that arranges and displays all video windows, which should be displayed, only on some displays in a multi-display constructed by arraying a plurality of displays; and
a power supply controller that controls power of said display in which said video window is not displayed.

2. The multi-display system according to claim 1, wherein said video window arrangement and display unit scales said video window to enable all said video windows that should be displayed to be arranged only on said some displays.

3. The multi-display system according to claim 1, wherein said video window arrangement and display unit displays only said video windows corresponding to a previously-selected display target video image only on said some displays.

4. The multi-display system according to claim 1, wherein said video window arrangement and display unit displays said video windows, which are displayed on said displays in response to a low-power-consumption mode.

5. The multi-display system according to claim t wherein said video window arrangement and display unit lays all said video windows, which should be displayed, only on said some displays based on a layout of previously-set said video windows.

6. The multi-display system according to claim 1, wherein said power supply controller powers off said display in which said video window is not displayed.
